(19) United States
(12) Patent Application Publication
(10) Pub. No.: US 2015/0071357 A1
(43) Pub. Date: Mar. 12, 2015

(54) PARTIAL INTRA BLOCK COPYING FOR VIDEO CODING

(71) Applicant: QUALCOMM Incorporated, San Diego, CA (US)

(72) Inventors: Chao Pang, San Diego, CA (US); Joel Sole Rojals, La Jolla, CA (US); Liwei Guo, San Diego, CA (US); Rajan Laxman Joshi, San Diego, CA (US); Marta Karczewicz, San Diego, CA (US)

(21) Appl. No.: 14/484,097

(22) Filed: Sep. 11, 2014

Related U.S. Application Data
(60) Provisional application No. 61/877,074, filed on Sep. 12, 2013.
(60) Provisional application No. 61/888,857, filed on Oct. 9, 2013.
(60) Provisional application No. 61/891,291, filed on Oct. 15, 2013.
(60) Provisional application No. 61/926,177, filed on Jan. 10, 2014.

(51) Int. Cl. H04N 19/593

(52) U.S. Cl. CPC H04N 19/00763
USPC 375/240.16

(57) ABSTRACT

In general, techniques are described for coding a current video block within a current picture based on a predictor block within the current picture, the predictor block identified by a block vector. The techniques include identifying an unavailable pixel of the predictor block, obtaining a value for the unavailable pixel based on at least one neighboring reconstructed pixel of the unavailable pixel, and coding the current video block based on a version of the predictor block that includes the obtained value for the unavailable pixel. The unavailable pixel may be located outside of a reconstructed region of the current picture.

This application claims the benefit of U.S. Provisional Application No. 61/877,074, filed Sep. 12, 2013, U.S. Provisional Application No. 61/888,857, filed Oct. 9, 2013, U.S. Provisional Application No. 61/891,291, filed Oct. 15, 2013, and U.S. Provisional Application No. 61/926,177, filed Jan. 10, 2014, the entire contents of each of which is incorporated by reference herein in its entirety.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video picture or a portion of a video picture) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized.

### SUMMARY

In general, this disclosure describes techniques for performing Intra-prediction for video coding. More particularly, this disclosure describes techniques for facilitating Intra Block Copying (Intra BC). Intra BC refers to Intra-prediction techniques in which a current video block is coded based on a prediction block within the same picture. The prediction block within the same picture is identified by a vector.

Some or all of a prediction block may not be located within a region of the picture that has been reconstructed, or is otherwise unavailable for prediction of the current block. This disclosure describes techniques that permit the Intra BC using prediction blocks that are not located entirely within a reconstructed region of the picture. In some examples, pixel padding or other techniques may be used to make available, for Intra BC prediction of the current video block, prediction blocks that are not entirely located within the reconstructed region. Such techniques may be used to generate samples that would otherwise be unavailable, e.g., due to being at least partially outside of a reconstructed region of the picture. The techniques of this disclosure may improve efficiency and accuracy of predicting current video blocks based on previously coded video blocks using Intra BC.

In one example, a method of encoding or decoding a current video block within a current picture based on a predictor block within the current picture, where the predictor block is identified by a block vector, includes identifying an unavailable pixel of the predictor block. In this example, the unavailable pixel is located outside of a reconstructed region of the current picture. In this example, the method also includes obtaining a value for the unavailable pixel based on at least one neighboring reconstructed pixel of the unavailable pixel. In this example, the method further includes, encoding or decoding the current video block based on a version of the predictor block that includes the obtained value for the unavailable pixel.

In another example, a device for encoding or decoding a current video block within a current picture based on a predictor block within the current picture, where the predictor block is identified by a block vector, includes a memory configured to store data associated with the current picture, and one or more processors. In this example, the one or more processors are configured to identify an unavailable pixel of the predictor block, obtain a value for the unavailable pixel based on at least one neighboring reconstructed pixel of the unavailable pixel, and encode or decode the current video block based on a version of the predictor block that includes the obtained value for the unavailable pixel. In this example, the unavailable pixel is located outside of a reconstructed region of the current picture.

In another example, a device for encoding or decoding a current video block within a current picture based on a predictor block within the current picture, where the predictor block is identified by a block vector, includes means for identifying an unavailable pixel of the predictor block, means for obtaining a value for the unavailable pixel based on at least one neighboring reconstructed pixel of the unavailable pixel, and means for encoding or decoding the current video block based on a version of the predictor block that includes the obtained value for the unavailable pixel. In this example, the unavailable pixel is located outside of a reconstructed region of the current picture.

In another example, a computer-readable storage medium stores instructions that, when executed, cause one or more processors of a device to encode or decode a current video block within a current picture based on a predictor block within the current picture by at least identifying an unavailable pixel of the predictor block, obtaining a value for the unavailable pixel based on at least one neighboring reconstructed pixel of the unavailable pixel, and encoding or decoding the current video block based on a version of the predictor block that includes the obtained value for the unavailable pixel. In this example, the unavailable pixel is located outside of a reconstructed region of the current picture.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIG. 4 is a conceptual diagram illustrating an example predictive video block and motion vector, in accordance with the techniques of the present disclosure.

FIGS. 5A-5C are conceptual diagrams illustrating examples of an intra-prediction process including Intra BC using example predictive video blocks that are at least partially outside of a reconstructed region, in accordance with the techniques of the present disclosure.

FIGS. 6-9 are conceptual diagrams illustrating example techniques for padding unavailable pixels of a predictor block.

FIG. 10 is a flow diagram illustrating example operations of a video coder to code a current block within a current picture based on a predictor block within the current picture that includes at least one pixel located outside of a reconstructed region of the current picture, in accordance with one or more techniques of the present disclosure.

### DETAILED DESCRIPTION

A video sequence is generally represented as a sequence of pictures. Typically, block-based coding techniques are used to code each of the individual pictures. That is, each picture is divided into blocks, and each of the blocks is individually coded. Coding a block of video data generally involves forming predicted values for pixels in the block and coding residual values. The prediction values are formed using pixel samples in one or more predictive blocks. The residual values represent the differences between the pixels of the original block and the predicted pixel values. Specifically, the original block of video data includes an array of pixel values, and the predicted block includes an array of predicted pixel values. The residual values represent to pixel-by-pixel differences between the pixel values of the original block and the predicted pixel values.

Prediction techniques for a block of video data are generally categorized as intra-prediction and inter-prediction. Intra-prediction, or spatial prediction, generally involves predicting the block from pixel values of neighboring, previously coded blocks. Inter-prediction, or temporal prediction, generally involves predicting the block from pixel values of one or more previously coded pictures (e.g., frames or slices).

Many applications, such as remote desktop, remote gaming, wireless displays, automotive infotainment, cloud computing, etc., are becoming routine in daily lives. Video contents in these applications are usually combinations of natural content, text, artificial graphics, etc. In text and artificial graphics region, repeated patterns (such as characters, icons, symbols, etc.) often exist. Intra Block Copying (BC) is a technique which may enable a video coder to remove such redundancy and improve intra-picture coding efficiency. In some instances, Intra BC alternatively may be referred to as Intra motion compensation (MC).

According to some Intra BC techniques, video coders may use blocks of previously coded video data that are either directly above or directly in line horizontally with the current block of video data in the same picture for prediction of the current video block. In other words, if a picture of video data is imposed on a 2-D grid, each block of video data would occupy a unique range of x-values and y-values. Accordingly, some video coders may predict a current block of video data based on blocks of previously coded video data that share only the same set of x-values (i.e., vertically in-line with the current video block) or the same set of y-values (i.e., horizontally in-line with the current video block).

Other Intra BC techniques, are described in Pang et al., “Non-RCE3: Intra Motion Compensation with 2-D MVs,” Document: JCTVC-N0256, JCT-VC of ITU-T SG 16 WP 3 and ISO/IEC JTC 1/SC 29/WG 11, 14^{th} Meeting: Vienna, AT 25 Jul.-2 Aug. 2013 (hereinafter “JCTVC-N0256”). At the JCT-VC meeting in Vienna (July 2013), Intra BC was adopted in the High Efficiency Video Coding (HEVC) Range Extension standard. According to JCTVC-N0256, a video coder may determine a two-dimensional motion vector which identifies a prediction block within the same picture as the current video block. In some examples, the motion vector may also be referred to as a block vector, an offset vector, or a displacement vector. In any case, the two-dimensional motion vector has a horizontal displacement component and a vertical displacement component, each of which may be zero or non-zero. The horizontal displacement component represents a horizontal displacement between the predictive block of video data, or prediction block, and a current block of video data and the vertical displacement component represents a vertical displacement between the prediction block of video data and the current block of video data. For Intra BC, the pixels of the predictive block are used as predictive samples for corresponding pixels in the block that is being coded. The video coder may additionally determine a residual block of video data based on the current block of video data and the prediction block, and code the two-dimensional motion vector and the residual block of video data.

Some proposals for Intra BC restrict the motion vector such that it only points to prediction blocks that reside entirely within a reconstructed region of the current video block. The reconstructed region, according to the typical raster order in which blocks are reconstructed in the coding process, generally includes blocks that are above the current block and blocks that are to the left of, but not below, the current video block. The reconstructed region generally does not include blocks that are below the current block, or the right of, but not above, the current video block. With the limitation that prediction blocks are required to be within a reconstructed region, prediction blocks used for Intra BC must be reconstructed and be within the same picture, slice, and/or tile as the current video block. In addition, prediction blocks used for Intra BC cannot overlap the current video block, i.e., because the current video block is not yet reconstructed and therefore does not form part of the reconstructed region. However, considering predictor blocks that reside at least partially outside the reconstructed region to be unavailable for Intra BC may unnecessarily limit coding possibilities for a video encoder and potentially degrade coding efficiency.

This disclosure describes pixel padding or other techniques to make prediction blocks that would otherwise be unavailable for Intra BC, e.g., due to being at least partially outside of a reconstructed region of the picture, available for Intra BC prediction of the current video block. By including more video blocks in the predictive set, a video coder may achieve more accurate prediction of the current video block, thereby increasing coding efficiency. In some examples, prediction blocks that reside partially outside the reconstructed region, such as prediction blocks that partially overlap the current video block, may be used for Intra BC.

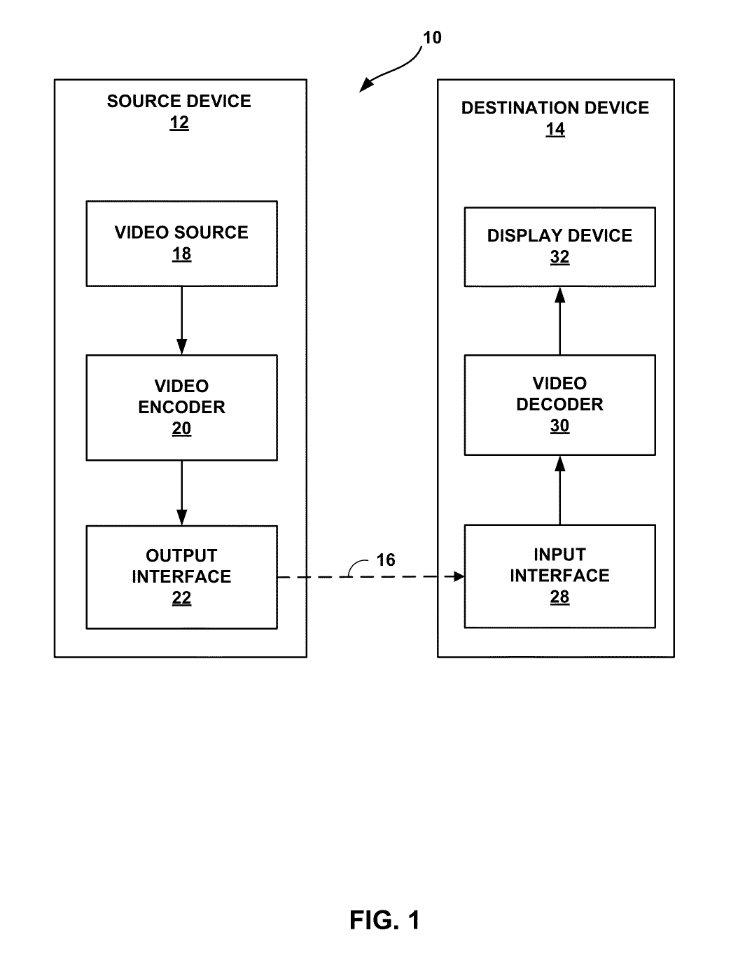

FIG. 1 is a block diagram illustrating an example video encoding and decoding system 10 that may utilize techniques for filtering video data. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12.

Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for performing transformation in video coding. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for performing Intra BC in video coding may be performed by any digital video encoding and/or decoding device. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined video encoder/decoder (codec). A device including video encoder 20 and/or video decoder 30 may comprise an integrated circuit, a microprocessor, and/or a wireless communication device, such as a cellular telephone.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to storage device 24) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

Video encoder 20 and video decoder 30 may operate according to a video compression standard, such as the ITU-T H.264 standard, alternatively referred to as MPEG-4, Part 10, Advanced Video Coding (AVC), or extensions of such standards. The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. Other examples of video compression standards include MPEG-2 and ITU-T H.263.

While the techniques of this disclosure are not limited to any particular coding standard, the techniques may be relevant to the HEVC standard and particularly to HEVC range extensions such as screen content coding. The HEVC standardization efforts are based on a model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-five intra-prediction encoding modes.

In general, the working model of the HM describes that a video picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive coding tree units (CTUs). Each of the CTUs may comprise a coding tree block of luma samples, two corresponding coding tree blocks of chroma samples, and syntax structures used to code the samples of the coding tree blocks. In a monochrome picture or a picture that have three separate color planes, a CTU may comprise a single coding tree block and syntax structures used to code the samples of the coding tree block.”

A video picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs. A CU may comprise a coding block of luma samples and two corresponding coding blocks of chroma samples of a picture that has a luma sample array, a Cb sample array and a Cr sample array, and syntax structures used to code the samples of the coding blocks. In a monochrome picture or a picture that have three separate color planes, a CU may comprise a single coding block and syntax structures used to code the samples of the coding block. A coding block is an N×N block of samples.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU in the HEVC standard has a purpose similar to that of a macroblock of the H.264 standard. However, a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs.

In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. A prediction block may be a rectangular (i.e., square or non-square) block of samples on which the same prediction is applied. A PU of a CU may comprise a prediction block of luma samples, two corresponding prediction blocks of chroma samples of a picture, and syntax structures used to predict the prediction block samples. In a monochrome picture or a picture that have three separate color planes, a PU may comprise a single prediction block and syntax structures used to predict the prediction block samples.

TUs may include coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU. A transform block may be a rectangular block of samples on which the same transform is applied. A transform unit (TU) of a CU may comprise a transform block of luma samples, two corresponding transform blocks of chroma samples, and syntax structures used to transform the transform block samples. In a monochrome picture or a picture that has three separate color planes, a TU may comprise a single transform block and syntax structures used to transform the transform block samples.

Following transformation, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Video encoder 20 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan.

After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

Video encoder 20 may further send syntax data, such as block-based syntax data, picture-based syntax data, and group of pictures (GOP)-based syntax data, to video decoder 30, e.g., in a picture header, a block header, a slice header, or a GOP header. The GOP syntax data may describe a number of pictures in the respective GOP, and the picture syntax data may indicate an encoding/prediction mode used to encode the corresponding picture.

Video decoder 30, upon obtaining the coded video data, may perform a decoding pass generally reciprocal to the encoding pass described with respect to video encoder 20. For example, video decoder 30 may obtain an encoded video bitstream that represents video blocks of an encoded video slice and associated syntax elements from video encoder 20. Video decoder 30 may reconstruct the original, unencoded video sequence using the data contained in the bitstream.

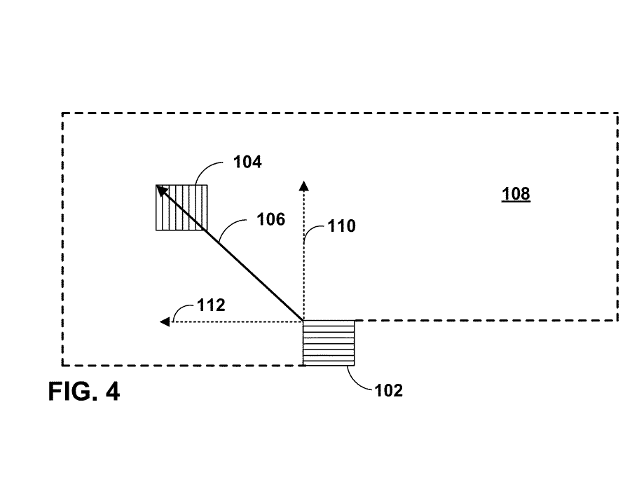

Many applications, such as remote desktop, remote gaming, wireless displays, automotive infotainment, cloud computing, or the like, are becoming routine in daily personal lives. Video content in these applications are typically combinations of natural content, text, artificial graphics, and the like. In text and artificial graphics, region of the content may include repeated patterns (such as characters, icons, and symbols to provide a few examples) often exist. Intra block copying (BC) is a technique that enables removal of this kind of redundancy, thereby potentially improving the intra-picture coding efficiency, e.g., as reported in JCT-VC N0256. At a recent JCT-VC meeting, Intra BC was adopted in the HEVC Range Extension standard (which has since been moved to the Screen Contents Coding extension of HEVC). As illustrated in more detail in the example of FIG. 4, for a current coding unit (CU) (e.g., current video block 102 of FIG. 4) coded using Intra BC, video encoder 20 may obtain a prediction signal (e.g., prediction block 104 of FIG. 4) (which may also be referred to as a “prediction block”) from an already reconstructed region (e.g., reconstructed region 108 of FIG. 4) in the same picture. In some instances, video encoder 20 may encode a vector, e.g., block vector 106 of FIG. 4, which indicates the position of the prediction block displaced from the current CU. The block vector, in some instances, also may be referred to as an offset vector, displacement vector, or motion vector. Video encoder 20 also may encode residual data indicating differences between the pixel values of the current video block and the predictive samples in the predictive block.

In a process described in JCT-VC N0256, the search region (i.e., the region from which the prediction block may be selected) may be restricted to be in the reconstructed region of a coding tree unit (CTU) to the left of the current CTU, potentially without in-loop filtering. However, the search region restrictions proposed in JCT-VC N0256 may not yield desirable prediction blocks for certain coding units (CUs) of the current CTU, such as CUs at boundaries of slices/tiles/frames/pictures. For example, when multiple slices are allowed for a picture and the prediction block is from a different slice, the current CU (which is another way of referring to a video block) coded with Intra BC mode may not be correctly decoded. Also, as another example, when the block vector points to a position that is out of a current picture (meaning that the search region extends beyond the bounds of the picture) and no padding scheme is defined, then the CU coded with the Intra BC mode may not be correctly decoded as well.

In accordance with various aspects of the techniques described in this disclosure, video encoder 20 may determine a search region that can be used for Intra BC such that the search region may be inside the same slice/tile in which the current CU resides. For example, with this restriction, when the possible search region is set to be the reconstructed region of the left CTU and current CTU as in JCT-VC N0256, the left CTU may be used only when this left CTU is in the same slice/tile as that of the current CTU. In other words, when the left CTU and the current CTU are in different slices/tiles, the video encoder 20 may only determine that the current CTU without in-loop filtering is used for Intra BC. In this respect, video encoder 20 may be configured to perform the Intra BC process to encode a current block of a picture such that pixels from a different slice or a different tile than that in which the current block resides are excluded from a search region used for the Intra BC process. In this way, video encoder 20 may ensure that the pixels of the prediction block are available for use when predicting the current CU. However, in some examples, it may be desirable for video encoder 20 to select a prediction block that includes one or more unavailable pixels, such as where the prediction block that includes the one or more unavailable pixels is a close match for the current CU.

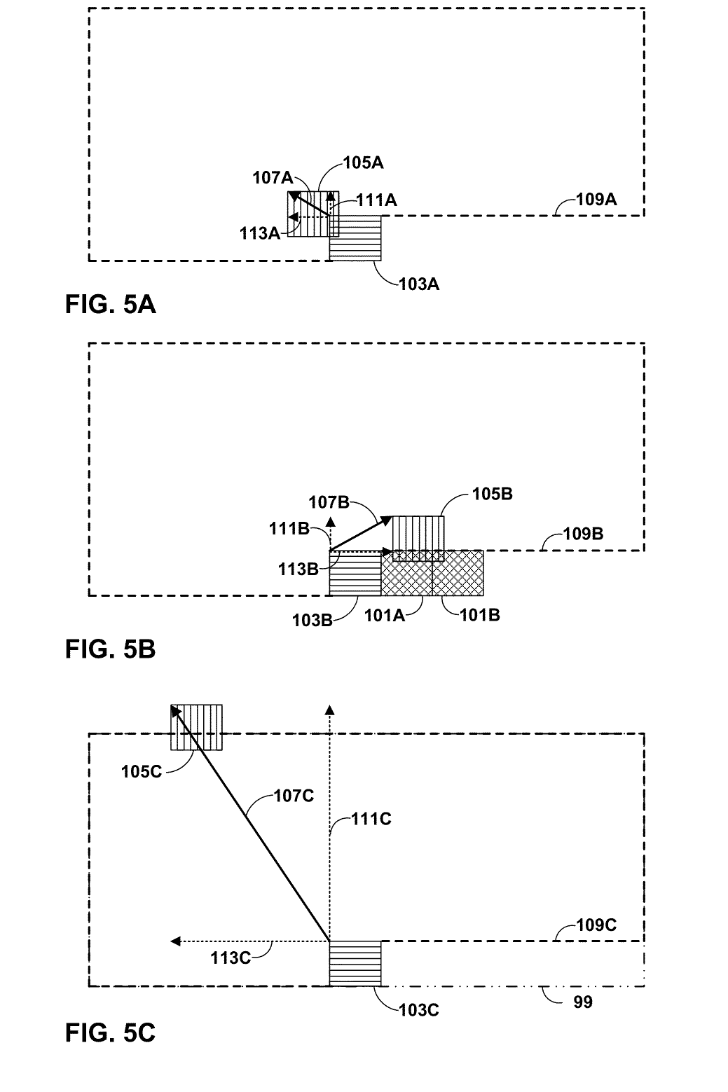

In accordance with one or more aspects of the techniques described in this disclosure, video encoder 20 may select a prediction block that includes one or more pixels that are unavailable to predict a current block. In general, pixels located outside the picture, slice, or tile, pixels that overlap with the current block, or pixels that are otherwise not within a region of reconstructed pixels for the current block, may be considered unavailable. For instance, one or more of the pixels included in the prediction block may be located outside of the reconstructed region. In other words, one or more pixels of a prediction block used for Intra BC may reside outside of a picture, slice, or tile of a current video block and/or outside of a reconstructed region for the current video block. In some examples, one or more pixels of the prediction block may overlap partially with the current video block. In such examples, video encoder 20 may obtain values for the one or more unavailable pixels using any of a variety of padding techniques. In some examples, the values of the unavailable pixels may be obtained based on values of available pixels, such as pixels located within the reconstructed region. For instance, video encoder 20 may use padding techniques to obtain values for the one or more unavailable pixels. Additional details of the padding techniques are discussed below with reference to FIGS. 5-9. Once the values for the one or more unavailable pixels are obtained, video encoder 20 may enlarge the search region to include the unavailable pixels with the obtained values. In this way, video encoder 20 may perform Intra BC using a prediction block that includes one or more pixels located outside of a reconstructed region.

Video encoder 20 may encode the current block using the obtained values for the one or more unavailable pixels. For instance, video encoder 20 may determine a residual block that represents pixel differences between a version of the prediction block that includes the obtained values for the one or more unavailable pixels and the current block, and encode the determined residual block along with a block vector that represents a location of the prediction block.

Video decoder 30 also may be configured to use techniques that are generally reciprocal to those described above with respect to video encoder 20. In this respect, video decoder 30 may be configured to perform an Intra BC process to decode a coded current block of a picture using a prediction block that includes one or more pixels unavailable to predict the current block. In some examples, video decoder 30 may obtain values for the one or more unavailable pixels based on values of available pixels, such as pixels located within the reconstructed region. For instance, video decoder 30 may use padding techniques to obtain values for the one or more unavailable pixels. In some examples, the padding techniques used by video decoder 30 may be identical to the padding techniques used by video encoder 20 (i.e., such that both video encoder 20 and video decoder 30 obtain the same values for the unavailable pixels). In this way, video decoder 30 may perform Intra BC using a prediction block that includes one or more unavailable pixels.

Video decoder 30 may decode the current block using the obtained values for the one or more unavailable pixels. For instance, video decoder 30 may generate the current block based on a residual block that represents pixel differences between a version of the prediction block that includes the obtained values for the one or more unavailable pixels and the current block.

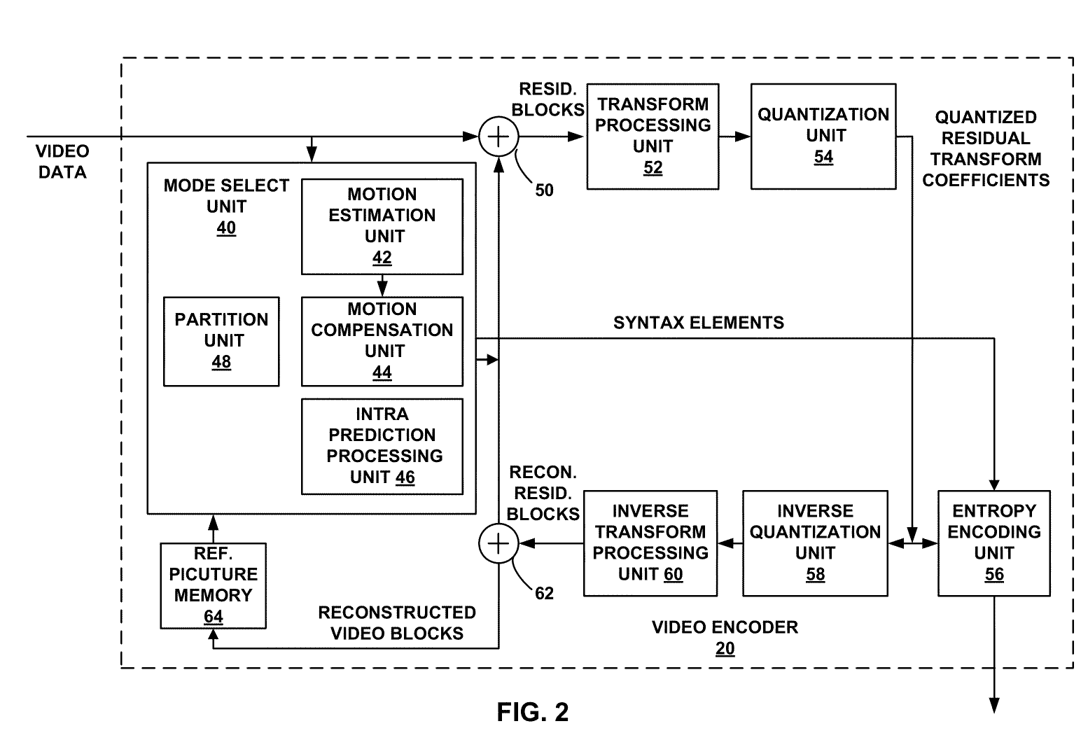

FIG. 2 is a block diagram illustrating an example of a video encoder that may implement the Intra BC and pixel padding techniques described herein. In the example of FIG. 2, video encoder 20 may perform intra- and inter-coding of video blocks within video slices. Intra-coding relies on spatial prediction to reduce or remove spatial redundancy in video within a given video picture. Intra-coding performed by video encoder 20 may include Intra BC and pixel padding according to the techniques described in this disclosure. Inter-coding relies on temporal prediction to reduce or remove temporal redundancy in video within adjacent pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video picture to be encoded. In the example of FIG. 2, video encoder 20 includes mode select unit 40, reference picture memory 64, summer 50, transform processing unit 52, quantization unit 54, and entropy encoding unit 56. Mode select unit 40, in turn, includes motion compensation unit 44, motion estimation unit 42, intra-prediction processing unit 46, and partition unit 48. For video block reconstruction, video encoder 20 also includes inverse quantization unit 58, inverse transform processing unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video picture, frame, tile, or slice to be coded. A picture may be partitioned into slices and tiles, as well as video blocks within slices or tiles, by partition unit 48. Motion estimation unit 42 and motion compensation unit 44 perform inter-predictive coding of the received video block relative to one or more blocks in one or more reference pictures to provide temporal prediction. Intra-prediction processing unit 46 may additionally or alternatively perform intra-predictive coding of the received video block relative to one or more neighboring blocks in the same picture or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a picture or slice into LCUs (CTUs), and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference picture. Mode select unit 40 also provides syntax elements, such as motion vectors, block vectors, intra-mode indicators, partition information, and other such syntax information, to entropy encoding unit 56. The syntax information may be included within the encoded bitstream, such as within slice headers or parameter sets.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. In the context of inter-prediction, a motion vector, for example, may indicate the displacement of a PU of a video block within a current video picture relative to a predictive block within a reference picture (or other coded unit) relative to the current block being coded within the current picture (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

Intra-prediction unit 46 may perform an intra-prediction process for selecting a predictive block of video data and the specific information to provide to entropy encoding unit 56 in accordance with one or more of the Intra BC techniques described below with respect to FIGS. 4-9. In some examples, intra-prediction unit 46 may generate block vectors and select predictive blocks in a manner similar to that described above with respect to motion estimation unit 42 and motion compensation unit 44. In other examples, motion estimation unit 42 and motion compensation unit 44 may, in whole or in part, perform such functions for intra motion compensation according to the techniques described herein. In either case, for intra motion compensation, a predictive block may be a block that is found to closely match the block to be coded, in terms of pixel difference, which may be determined by sum of absolute difference (SAD), sum of square difference (SSD), or other difference metrics, and identification of the block may include calculation of values for sub-integer pixel positions. In some examples, such as where one or more pixels of a candidate predictive block are unavailable to predict the block to be coded, intra-prediction 46 may utilize a padded version of the candidate predictive block when determining the pixel difference.

Intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include configuration data in the transmitted bitstream. The configuration data may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data, e.g., matrix subtraction of the prediction block, from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms, or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform processing unit 60 apply inverse quantization and inverse transformation, respectively, to reconstruct the residual block in the pixel domain, e.g., for later use as a reference block. Motion compensation unit 44 may reconstruct a block of video data by adding the residual block to a predictive block of one of the pictures of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video picture, or by motion estimation unit 42, motion compensation unit 44, or intra-prediction unit 46 as a reference block for regular intra coding or Intra BC according to the techniques described herein.

Motion estimation unit 42 may determine one or more reference pictures, which video encoder 20 may use to predict the pixel values of one or more PUs that are inter-predicted. Motion estimation unit 42 may store the reference pictures in a decoded picture buffer (DPB) until the pictures are marked as unused for reference. Mode select unit 40 of video encoder 20 may encode various syntax elements that include identifying information for one or more reference pictures.

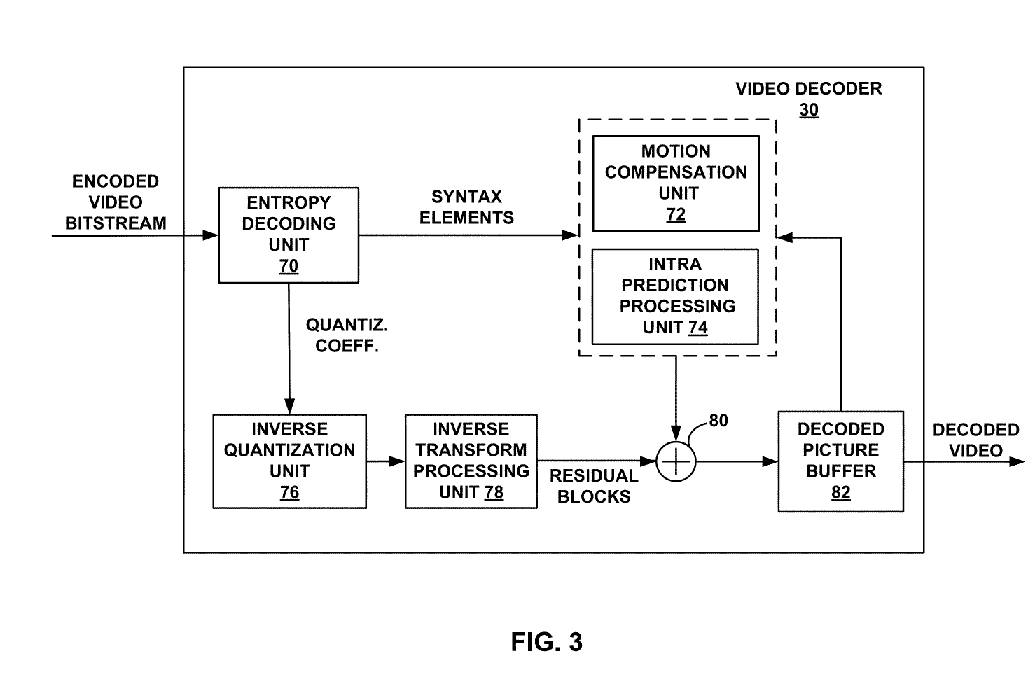

FIG. 3 is a block diagram illustrating an example of video decoder 30 that may implement techniques for intra-picture motion compensation described herein. In the example of FIG. 3, video decoder 30 includes an entropy decoding unit 70, motion compensation unit 72, intra prediction unit 74, inverse quantization unit 76, inverse transformation unit 78, reference picture memory 82, and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy-decodes the bitstream to generate quantized coefficients, motion vectors or intra-prediction mode indicators, and other syntax elements. Entropy decoding unit 70 forwards the motion vectors and other syntax elements to motion compensation unit 72. Video decoder 30 may receive the syntax elements at the video slice level and/or the video block level. In some examples, syntax elements may be included in a slice header, or a picture parameter set referred to (directly or indirectly) by the slice header

When the video slice is coded as an intra-coded (I) slice, intra prediction unit 74 may generate prediction data for a video block of the current video slice based on a signaled intra prediction mode and data from previously decoded blocks of the current picture. When the video picture is coded as an inter-coded (i.e., B or P) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference picture lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice. For intra-prediction including intra motion compensation according to the techniques described herein, motion compensation unit 72 and/or intra prediction processing unit 74 may perform an Intra BC process with pixel padding in accordance with one or more of the techniques described below with respect to FIGS. 4-9. The Intra BC process may include identifying a reference or predictor block within the same picture as the current block based on a block vector, and using the predictor block as a prediction for the current block.

Motion compensation unit 72 and/or intra prediction processing unit 74 may also perform interpolation based on interpolation filters. Motion compensation unit 72 and/or intra prediction processing unit 74 may use interpolation filters as used by video encoder 20 during encoding of the video blocks to calculate interpolated values for sub-integer pixels of reference blocks. In this case, motion compensation unit 72 and/or intra prediction processing unit 74 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform processing unit 78 applies an inverse transform, e.g., an inverse DCT, an inverse integer transform, or a conceptually similar inverse transform process, to the transform coefficients in order to produce residual blocks in the pixel domain. Each residual block may include residual values indicating differences between inter- or intra-predictive samples and the original pixel values of the current video block to be decoded.

After motion compensation unit 72 and/or intra prediction processing unit 74 generates the predictor block for the current video block based on the motion vectors and/or other syntax elements, video decoder 30 forms a decoded video block by summing the residual blocks from inverse transform processing unit 78 with the corresponding predictive blocks generated by motion compensation unit 72. The blocks resulting from summation may be referred to as reconstructed blocks. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given picture are then stored in decoded picture buffer 82, which stores reference pictures used for subsequent motion compensation. Decoded picture buffer 82 also may store decoded video for later presentation on a display device, such as display device 32 of FIG. 1.

FIG. 4 illustrates an example of an intra-prediction process including Intra BC in accordance with the techniques of the present disclosure. According to one example intra-prediction process, video encoder 20 may select a predictor video block from a set of previously coded and reconstructed blocks of video data. In the example of FIG. 4, reconstructed region 108 includes the set of previously coded and reconstructed video blocks. The blocks in the reconstructed region 108 may represent blocks that have been decoded and reconstructed by video decoder 30 and stored in decoded picture buffer 82, or blocks that have been decoded and reconstructed in the reconstruction loop of video encoder 20 and stored in reference picture memory 64. Current block 102 represents a current video block to be coded. Predictor block 104 represents a reconstructed video block, in the same picture as current block 102, which is used for Intra BC prediction of current block 102.

In some examples, a search for predictive blocks used for Intra BC may be constrained to predictive blocks that are located entirely within reconstructed region 108. In other examples, predictive blocks used for Intra BC may be at least partially outside of reconstructed region 108. In this case, padding processes may be used to generate predictive pixel samples that are outside of reconstructed region 108 and would otherwise be unavailable for Intra BC.

Block vector 106 represents the location of predictor block 104 relative to current block 102. Block vector 106 may also be referred to as a motion vector, displacement vector, or offset vector. Block vector 106, in the example of FIG. 4, is two-dimensional, and includes horizontal displacement component 112 and vertical displacement component 110, which represent the horizontal and vertical displacement, respectively, of predictor block 104 relative to current video block 102.

Video encoder 20 may select predictor block 104 for current video block 102 from among available reconstructed video blocks within reconstructed region 108 of the picture including current block 102. Video encoder 20 may determine a residual block based on the difference between pixel values of current block 102 and corresponding pixel values of predictor block 104, and transform, quantize and encode the residual block using the techniques described herein. Video encoder 20 may also encode information identifying block vector 106, with the residual, in the encoded video bitstream.

Video decoder 30 may decode the residual and the information identifying block vector 106 from the bitstream. Video decoder 30 may identify predictor block 104 within the reconstructed region 108 based on block vector 106. Video decoder 30 may reconstruct current block 102 based on the residual block and predictor block 104.

In some examples, the resolution of horizontal displacement component 112 and vertical displacement component 110 can have integer pixel precision. In other examples, the resolution of horizontal displacement component 112 and vertical displacement component 110 can be sub-pixel (i.e., fractional) precision. In still other examples, the resolution of horizontal displacement component 112 and vertical displacement component 110 can be adapted based on a specific level.

For example, a flag at slice level signaled by video encoder 20 for each slice may indicate whether the resolution of horizontal displacement component 112 and vertical displacement component 110 is integer pixel resolution or is not integer pixel resolution. If the flag indicates that the resolution of horizontal displacement component 112 and vertical displacement component 110 is not integer pixel resolution, it may be inferred that the resolution is sub-pixel resolution. Alternatively, video encoder 20 may signal a syntax element for each slice to indicate the resolution of horizontal displacement component 112 and vertical displacement component 110. Signaling syntax elements, or other data or information, may include transmission of the information, or storing the information, with an encoded video bitstream.

In other examples, horizontal displacement component 112 and vertical displacement component 110 may have different resolutions. For example, horizontal displacement component 112 may have integer pixel resolution and vertical displacement component 110 may have sub-pixel resolution, or the other way around. In still other examples, instead of a flag or a syntax element, the resolution of horizontal displacement component 112 and vertical displacement component 110 may be inferred, e.g., by video decoder 30, from resolution context information. Resolution context information may be the specific color space (e.g., YUV, RGB, or the like), the specific color format (e.g., 4:2:0, 4:4:4, or the like), the picture size, the frame rate, or the quantization parameter (QP). In at least some examples, the resolution for horizontal displacement component 112 and the resolution for vertical displacement component 110 may be determined based on information related to previously coded pictures. In this manner, the resolution of horizontal displacement component 112 and the resolution for vertical displacement component 110 may be pre-defined, signaled, or may be inferred from side information (e.g., resolution context information), or based on already encoded pictures.

In one example, horizontal displacement component 112 and vertical displacement component 110 may be coded, e.g., encoded or decoded, using unary codes. In other examples, horizontal displacement component 112 and vertical displacement component 110 may be coded using exponential Golomb or Rice-Golomb codes.

In some examples, horizontal displacement component 112 and vertical displacement component 110 may only indicate blocks above the current video block and blocks to the left of (but not below) the current video block, and thus sign bits may not need to be retained or signaled. In some examples, a frame of reference may be constructed such that the regions above and to the left of the current video block may represent positive directions relative to the current video block. Accordingly, if only the video blocks above and/or to the left of the current video block are considered as candidate predictor blocks, sign bits may not be retained or transmitted because it may be pre-defined that all values of horizontal displacement component 112 and vertical displacement component 110 represent positive (or negative) values and indicate video blocks above and/or to the left of the current video block. In some examples, such as where horizontal displacement component 112 and/or vertical displacement component 110 may indicate regions other than those above and to the left of the current video block (i.e., regions below and/or to the right of the current video block), sign bits may be signaled.

In some examples, the maximum size of these block vectors (or the difference between one or more two-dimensional block vectors) in intra-prediction may be small due to pipeline constraints, i.e., to allow parallel processing of various units, e.g., slices or tiles, within a video picture, which would make video blocks in other slices or tiles unavailable as predictor blocks for the current video block in the current slice or tile. In such examples, the binarization of these two-dimensional block vectors can be done with truncated values. For example, some examples may employ truncated unary, truncated exponential-golomb, or truncated golomb-rice codes in entropy encoding the two-dimensional block vectors and horizontal displacement component 112 and vertical displacement component 110.

The truncation value used in any of the various truncated encoding schemes can be constant, for example if the truncation value is determined based on the LCU size. In some examples, the truncation value may be the same for horizontal displacement component 112 and vertical displacement component 110, and in other examples the truncation value may be different for horizontal displacement component 112 and vertical displacement component 110. As one illustrative example, if the size of an LCU is 64, e.g., 64×64, and the vertical components of the two-dimensional block vectors are limited to be within the LCU, then the truncation can be equal to 63 for the horizontal component of the two-dimensional block vector (in the example of FIG. 4, horizontal displacement component 112) and equal to 63−MinCUSize for the vertical component of the two-dimensional block vector (in the example of FIG. 4, vertical displacement component 110.

In some examples, the truncation value can be adaptive depending on the position of the current video block within the LCU. For example, if the vertical component of the two-dimensional block vector is limited to be within the LCU, then the vector binarization can be truncated to the difference between the top position of the block and the top position of the LCU.

The binarizations of the components of the two-dimensional block vector can be coded, e.g., encoded by video encoder 20 or decoded by video decoder 30, using CABAC context-based coding or bypass mode.

Because a search for predictive blocks can, in some examples, be performed only on the already encoded/reconstructed regions (e.g., reconstructed region 108 illustrated in FIG. 4), the distribution of the block vector (BV) may not be zero-centered, i.e. BV_x tends to be negative since pixels on the right of the CU (in the same row) have not been encoded/reconstructed; and BV_y tends to be negative since pixels below the current CU (in the same column) have not been encoded/reconstructed. Bypass coding is not context-adaptive and assumes equal probability for 0 and 1 (for sign it means equal probability of being positive or negative). Thus, the sign can be coded with a CABAC context (with an initial probability other than 0.5).

The following is a detailed example of how the BV can be coded by video encoder 20 (and decoded by video decoder 30). The coding of horizontal component of the block vector, denoted as BV_x, is described as an example. Note that the technique to be described can also be used for bvd_x, the difference between BV_x and its predictor; and could also apply to vertical component, BV_y, or its predictor, bvd_y. Predictors for BV_x and BV_y are discussed in greater detail below. The BV_x is represented by the sign, and a binarization string (for abs(BV_x)) b0 b1 . . . . The first bin b0 indicates if abs(BV_x)>0 (b0=1) or not (b0=0). The first bin b0 may be encoded using CABAC with a context. The b0 for BV_x and BV_y may have separate contexts (it is also possible that they share the same contexts. It is also possible that the i-th bin in BV coding for Intra BC share the same contexts with the i-th bin in BV coding for Inter coding. It is also possible that the i-th bins in BV coding of Intra BC and BV coding of Inter BC do not share contexts).

The following bins b1b2 . . . represent the value of abs(BV_X)−1 and may be encoded by video encoder 20 (and decoded by video decoder 30) using Exponential Golomb codes with parameter 3 in Bypass mode. It is possible that other orders of Exponential Golomb codes may be used, e.g., 1, 2, 4, 5. It is also possible that b1 represents if abs(BV_X)=1 (b1=1) or not (1)1=0). The bin b1 can be coded with Bypass mode or with CABAC context. Where b1 represents if abs(BV_X)=1, b2b3 . . . may represent the value of abs(BV_X)−2 and may be coded using Exponential Golomb codes with parameter 3 (or other orders of Exponential Golomb codes) in Bypass mode. The last bin may indicate the sign of BV_x, and may be coded in Bypass mode without any context. It is also possible that the sign bin can be coded using CABAC with one or multiple contexts. The sign bins for BV_x and BV_y may have separate contexts, or it is also possible that they share the same contexts.

In some examples, an intra-predicted CU can be split into a number of PUs, and each PU can have a different block vector. For example, a 2N×2N CU can be divided into 2 2N×N, or 2 N×2N, or 4 N×N, or ((N/2)×N+(3N/2)×N), or ((3N/2)×N+(N/2)×N), or (N×(N/2)+N×(3N/2)), or (N×(3N/2)+N×(N/2)), or 4 (N/2)×2N or 4 2N×(N/2).

The block vectors of the neighboring PUs can be used to predict the current block vector. In such examples, a difference between the current block vector and a predictive block vector from a neighboring PU, rather than the current block vector, may be encoded and decoded. If the vector is the first one of the CU (or LCU), then the predictor can be simply 0. Alternatively, a variable can be used to store the last coded block vector, and that last coded block vector may be used as the predictor for the current block vector.

In some examples, a predictor, such as PVi (where i may be x or y, representing the horizontal component or the vertical component of a two-dimensional block vector, respectively), is derived for each block vector component, and only the prediction error, Vdi (again, where i may represent x or y) is coded. The predictor can be the horizontal or vertical component of the two-dimensional block vector from the neighboring units, like the top one, the top left one, or the left one. The predictor can be a function (such as median) of the horizontal or vertical components of the two-dimensional block vector from the plurality of neighboring units.

Additionally, the selection of the method or methods used to determine the horizontal and vertical components of the two-dimensional block vectors of the current video block can be based on flags, syntax elements, or based on other information (such as the specific color space (e.g., YUV, RGB, or the like), the specific color format (e.g., 4:2:0, 4:4:4, or the like), the picture size, the frame rate, or the quantization parameter (QP), or based on previously coded picture).

Any of the methods described above can be used to code the block vector prediction error Vdi, the difference being that the sign has to be transmitted since Vdi can take negative values.

The prediction block may use reconstructed samples without in-loop filtering such as deblocking and sample adaptive offset (SAO) filtering. The coding, e.g., encoding or decoding, of Vi (where Vi represents a specific component of a two-dimensional block vector, such as horizontal displacement component 112 and vertical displacement component 110, where i represents either x or y, which in turn represent the horizontal component and the vertical component respectively) may be done using truncated unary codes where the maximum value is determined by the range of the block vector. In other examples, truncated Exponential Golomb or Rice Golomb codes may be used.

The techniques may be equally applicable to predicting luma block vectors and chroma block vectors. Furthermore, there may be only one block vector transmitted, e.g., either luma or chroma. Also, the other block vector(s), e.g., luma or chroma, may be derived from the transmitted block vector. As an example, if the transmitted block vector is in terms of luma pixels, the corresponding chroma block vector may be derived by possible down-sampling in both horizontal and vertical directions, or by horizontal down-sampling only. As a result, the search region limitation should consider the intersection of the luma allowed search region and the chroma allowed search region.

In JCT-VC N0256, the search region, from which prediction blocks for Intra BC may be selected, may be restricted to be in reconstructed region 108 of a CTU (or LCU) above or to the left of the current CTU. However, the search region restriction proposed in JCT-VC N0256 may not yield desirable prediction blocks for some coding units (CUs) of the current CTU, such as CUs at boundaries of slices/tiles/frames/pictures. For example, when a picture includes multiple slices and the prediction block is from a different slice than the current CU to be coded, the current CU coded with Intra BC mode may not be correctly decoded. Also, as another example, when the block vector is pointed to a position that is out of a current picture (meaning that the search region extends beyond the bounds of the picture), then the CU coded with the Intra BC mode may not be correctly decoded as well.

In accordance with some proposals, video encoder 20 may determine a search region, from which prediction blocks for Intra BC may be selected, that can be used for Intra BC such that this region is inside the same picture, slice and/or tile as the current CU. In some examples, in-loop filtering is not applied to the blocks within the search region for of the blocks for Intra BC.

In these and other examples, the prediction block in the reconstructed region may be restricted such that this prediction block cannot overlap with the current CU. In other words, since the current CU is not in the reconstructed region in some instances, the whole prediction block should be in the reconstructed region. By ensuring this prediction block is in the reconstructed region, mismatching (i.e., of available pixel values) between encoder and decoder may be avoided when Intra BC mode is used. As discussed below with reference to FIGS. 5-9, it is also possible that only part of the prediction block is in the reconstructed region, and the remaining part is not in the reconstructed region.

As described above, Intra BC, e.g., as described in JCTVC-N0256, enables removing intra-picture redundancy and improving the intra-picture coding efficiency. However, as described, an Intra BC process may be configured to restrict the block vector such that it only points to predictor blocks that are entirely within reconstructed region, i.e. predictor blocks for which all pixels of the predictor block reside within the reconstructed region. Additionally, some proposals for an Intra BC process may be configured to restrict the block vector such that the predictor block must be entirely (all pixels) within the same picture, slice and/or tile as the current block, and such that the predictor block cannot partially overlap with the current block. In some examples, an Intra BC process may be configured to restrict the block vector such that the predictor block is entirely within the same CTU (LCU) as the current video block, or within the same CTU or a left-neighboring CTU of the current video block. Such restrictions may facilitate parallel processing at the picture, slice, tile and/or CTU level, which would result in pixels from different pictures, slices, tiles and/or CTUs being unavailable (not reconstructed) for prediction of the current video block. The above methods may avoid the fetching of pixels outside of reconstructed region 108 by limiting the range of block vector to be possibly smaller than the region.

However, considering predictor blocks that may be partially outside of reconstructed region 108 to be unavailable for purposes of the Intra BC process may unnecessarily limit a video encoder and potentially degrade coding efficiency. This disclosure describes techniques for making prediction blocks that would otherwise be unavailable, e.g., due to being at least partially outside of a reconstructed region 108 of the picture, available for prediction of the current video block. The techniques may include padding, inpainting, or other techniques for generating predictive pixel samples for those pixels of a predictive block that reside outside of a reconstruction region. The generated pixels may include including pixels that may reside within a current block to be coded, i.e., as a result of a predictive block residing partially within the reconstructed region and partially within the current block to be coded such that the predictive block overlaps the block to be coded. By including more video blocks in the set of predictive blocks available for Intra BC process, a video coder, such as video encoder 20 and/or video decoder 30, may be able to select, among the larger set of predictive blocks, some predictive blocks that achieve more accurate prediction of the current video block for a given bit rate, which may increase coding efficiency.

According to one or more techniques of this disclosure, with further reference to FIG. 4, when only part of the prediction block 104 is within the reconstructed region 108, a video coder, e.g., video encoder 20 and/or video decoder 30, may obtain the remaining part which is not in the reconstructed region 108 using predefined methods, such as padding, inpainting, or other techniques. In some examples according to the techniques of this disclosure, when performing the Intra BC process for current block 102, a video coder may determine a region of a picture, e.g., an intended region such as reconstructed region 108. When the determined region extends beyond the picture, slice, tile, CTU (or CTU and neighboring CTU) in which the current block resides, the video coder may use the predefined methods to obtain pixel values for the portions outside of the boundary, e.g., pad the slice or the tile to generate a padded slice or a padded tile that is the same size as the determined region, and identify a prediction block within the determined region. The video coder may then, when coding the current block, code the current block based on the identified prediction block that includes the obtained pixels values for the portion of the predictor block outside of the intended region, e.g., reconstructed region 108.

“Pixel padding” may refer to adding and/or interpolating pixels that are not included in a currently reconstructed region. In some examples, if a pixel is outside the currently reconstructed region of the picture, slice, tile, CTU (or CTU and neighboring CTU) that includes current video block 102, this pixel may be replaced by the value of the closest pixel that is in the reconstructed region, e.g., current picture, slice, tile, CTU (or CTU and neighboring CTU). Such techniques may improve efficiency by limiting the amount of data that is retrieved from memory during coding.

In some examples, a video coder may obtain pixel values for a portion of predictor block 104 outside of the intended region by inpainting, e.g., applying a function or algorithm to a plurality of values in the reconstructed region. For purposes of this disclosure, inpainting may be considered to be a type of padding. The function or algorithm may consider one or more neighboring and/or non-neighboring pixel values based on proximity to the pixel value to be derived and/or based on a direction of the pixels within the reconstructed region relative to the pixel value to be derived. In still other examples, pixel padding could utilize interpolations that define unavailable pixel values based on available pixel values, or other techniques such as by using default values or zero values, or by extending the available pixel values to the unavailable pixel locations.

FIGS. 5A-5C are conceptual diagrams illustrating examples of an intra-prediction process including Intra BC using example predictive video blocks that are at least partially outside of a reconstructed region, in accordance with the techniques of the present disclosure. The techniques of FIGS. 5A-5C may be performed by one or more processors of a device, such as video encoder 20 illustrated in FIGS. 1 and 2, and/or video decoder 30 illustrated in FIGS. 1 and 3. For purposes of illustration, the techniques of FIGS. 5A-5C are described within the context of video encoder 20 and video decoder 30, although computing devices having configurations different than that of video encoder 20 and video decoder 30 may perform the techniques of FIGS. 5A-5C.

According to one or more techniques of this disclosure, video encoder 20 may select a predictor video block that is at least partially outside of a set of previously coded and reconstructed blocks of video data. In the example of FIGS. 5A-5C, respective reconstructed regions 109A-109C (collectively, “reconstructed regions 109”) include respective sets of previously coded and reconstructed video blocks, e.g., which may reside in reference picture memory 64 of video encoder 20 or decoded picture buffer 82 of video decoder 30. In some examples, reconstructed regions 109 may be examples of reconstructed region 108 of FIG. 4. Respective current blocks 103A-103C (collectively, “current blocks 103”) each represent a respective current video block to be coded. Respective predictor blocks 105A-105C (collectively, “predictor blocks 105”) each represent a reconstructed video block respectively used to predict current blocks 103 in an Intra BC process. Respective block vectors 107A-107C (collectively, “block vectors 107”) each represent respective locations of predictor blocks 105 relative to current blocks 103. Block vectors 107 may also be referred to as a displacement vectors, block vectors, or offset vectors. Block vectors 107 in the example of FIGS. 5A-5C are two-dimensional, and each include respective horizontal displacement component 113A-113C, and respective vertical displacement component 111A-111C, which respectively represent the horizontal and vertical displacement of predictor blocks 105 relative to current video blocks 103.

In operation, video encoder 20 may encode a current video block of a current picture by selecting a predictor block from among available reconstructed video blocks within a reconstructed region and/or video blocks that are at least partially outside of the reconstructed region. In the example of FIG. 5A, video encoder 20 may select predictor block 105A for current video block 103A that is at least partially outside of reconstructed region 109A because predictor block 105A overlaps current video block 103A. In the example of FIG. 5B, video encoder 20 may select predictor block 105B for current video block 103B that is at least partially outside of reconstructed region 109B because predictor block 105B overlaps video blocks 101A and 101B, which are unavailable because video blocks 101A and 101B are after current video block 103B in a raster coding order and therefore have not yet been reconstructed. In the example of FIG. 5C, video encoder 20 may select predictor block 105C for current video block 103C that is at least partially outside of reconstructed region 109C because predictor block 105C is at least partially outside of slice 99, which includes current video block 103C.

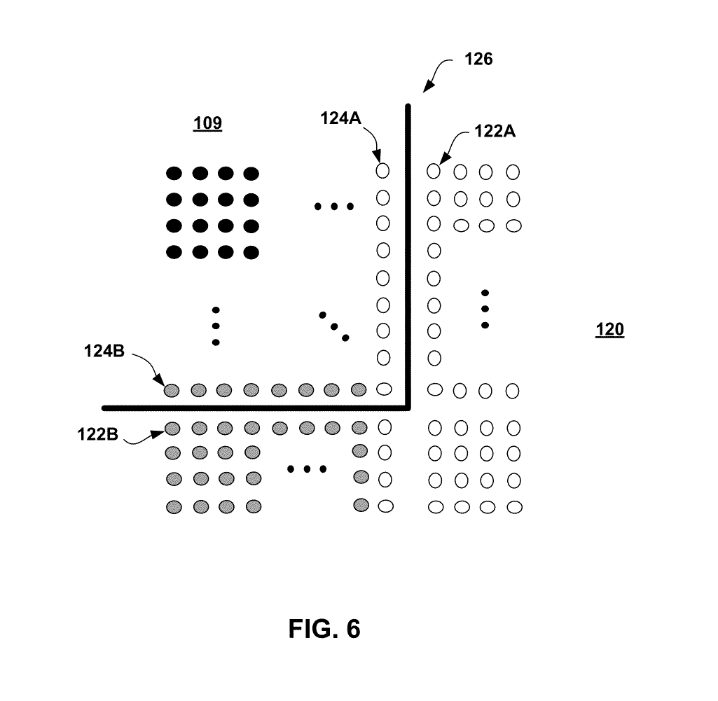

In any case, as predictor blocks 105 in each of the examples of FIGS. 5A-5C are at least partially outside of respective reconstructed regions 109, the actual values of one or more of the pixels included in each of predictor blocks 105 may be unavailable when predicting current video blocks 103. In accordance with one or more techniques of this disclosure, when predicting a current video block based on a predictor block that includes one or more unavailable pixels, video encoder 20 may obtain values for the one or more unavailable pixels using any of a variety of padding processes. In some examples, a padding process may generate values for the pixels based on values of one or more neighboring reconstructed pixels. For instance, video encoder 20 may obtain the value for a particular unavailable pixel by padding the unavailable pixel with a value determined based on at least one neighboring pixel of the particular unavailable pixel that is located in a reconstructed region (i.e., a neighboring reconstructed pixel). In the example of FIG. 5A, video encoder 20 may obtain pixel values for the unavailable pixels of predictor block 105A (i.e., the pixels of predictor block 105A that overlap current video block 103A) based on pixel values included in reconstructed region 109A. In this way, video encoder 20 may obtain a complete version of the predictor block (i.e., a version of the predictor block that includes values for each of the one or more unavailable pixels included in the predictor block). Additional details of example padding techniques are discussed below with reference to FIGS. 6-9.

In any case, video encoder 20 may determine a residual block based on the difference between the current block and the complete predictor block, and transform, quantize and encode the residual block using the techniques described herein. Video encoder 20 may also encode information identifying the block vector, with the residual, in the encoded video bitstream. In this way, by making prediction blocks that would otherwise be unavailable (e.g., due to being at least partially outside of a reconstructed region), available for prediction of the current video block, video encoder 20 may achieve more accurate prediction of the current video block, which may increase coding efficiency.

Video decoder 30 may decode the residual and the information identifying the block vector from the bitstream, and identify a predictor block for a current video block based on the block vector. Video decoder 30 may identify whether any pixels included in the identified predictor block are unavailable. For instance, video decoder 30 may identify whether any pixels included in the predictor block identified by the block vector are located outside of a reconstructed region of a picture that includes the current block.

Where one or more pixels included in the identified predictor block are unavailable, video decoder 30 may obtain values for the one or more unavailable pixels based on available pixels. For instance, video decoder 30 may obtain a value for a particular unavailable pixel based on at least one neighboring pixel of the particular unavailable pixel. In some examples, video decoder 30 may obtain the value for the particular unavailable pixel by padding the particular unavailable pixel with a value determined based on the at least one neighboring reconstructed pixel of the unavailable pixel. In this way, video decoder 30 may obtain a complete version of the predictor block (i.e., a version of the predictor block that includes values for each of the one or more unavailable pixels included in the predictor block).

In any case, video decoder 30 may decode the current video block based on the complete version of the predictor block. In this way, video decoder 30 may use predictor blocks that include one or more unavailable pixels.

FIGS. 6-9 are conceptual diagrams illustrating example techniques for padding unavailable pixels of a predictor block. FIG. 6, for example, illustrates a boundary 126 between an intended region, e.g., reconstructed region 109, and a region 120 of a picture in which pixel values have not been reconstructed. The boundary 126 may be, for example, a tile, slice, or LCU boundary. Pixels 122A and 122B are examples of pixels collectively referred to as unavailable pixels 122 that have not been reconstructed and therefore reside within non-reconstructed region 120. Pixels 124A and 124B are examples of pixels collectively referred to as pixels 124 within the reconstructed region that neighbor the boundary 126.

According to some example techniques of this disclosure, before each video block, e.g., CU, is encoded/decoded, a video coder, e.g., video encoder 20 and/or video decoder 30, may use a padding method to fill the part (or whole) of a prediction block 104 that is not in the reconstructed region 109 (called unavailable pixels) using the neighboring available reconstructed pixels 124. For example, as shown in FIG. 6, the solid line is the boundary between the available reconstructed pixels 124 and the unavailable pixels 122 which need to be padded.

In some examples, when horizontal neighboring reconstructed pixels 124 (indicated with unfilled circles in FIG. 6) are available (no matter whether vertical neighboring reconstructed pixels are available or not), the unavailable pixels are padded by horizontally copying the nearest available reconstructed pixel. In some examples, when vertical neighboring reconstructed pixels 124 (indicated with unfilled circles in FIG. 6) are available (no matter whether horizontal neighboring reconstructed pixels are available or not), the unavailable pixels are padded by vertically copying the nearest available reconstructed pixel. In some examples, when horizontal neighboring reconstructed pixels 124 are unavailable but vertical neighboring reconstructed pixels 124 (indicated with shaded-fill circles in FIG. 6) are available, the unavailable pixels 122 are padded by vertically copying the nearest available reconstructed pixel. In some examples, when vertical neighboring reconstructed pixels 124 are unavailable but horizontal neighboring reconstructed pixels 124 (indicated with shaded-fill circles in FIG. 6) are available, the unavailable pixels 122 are padded by horizontal copying the nearest available reconstructed pixel. In some examples, when both horizontal and vertical neighboring reconstructed pixels 124 are unavailable, such as the bottom right part of the pixels to be padded 122 in FIG. 6, the nearest available reconstructed pixel will be copied to pad such pixels, whether such pixel is above or to the left of the unavailable pixel.

In some examples, when both horizontal and vertical neighboring reconstructed pixels are available, the nearest pixels between horizontal and vertical neighboring reconstructed pixels will be copied for the padding, and either horizontal or vertical neighboring reconstructed pixels are copied for the padding in case the distances from the nearest horizontal and nearest vertical neighboring reconstructed pixels are the same. In some examples, the video coder may only do the padding in one of the directions, e.g., horizontal or vertical. In some examples, padding performed by the video coder may include copying the neighboring pixel value, or may include application of a function to the available neighboring pixel 124 to determine a padded value for the unavailable pixel 122 that is different from the value of the available neighboring pixel 124. In addition, if there are no neighboring reconstructed pixels available for padding an unavailable pixel, e.g., because the nearest reconstructed pixel is greater than a threshold distance from the unavailable pixel, then the value of (2<<(B−1)) may be used for the unavailable pixel, where B is the bitdepth of the input (e.g., video data). Selecting a value of (2<<(B−1)), in effect, assigns a mid-range bitdepth value of the unavailable pixel.

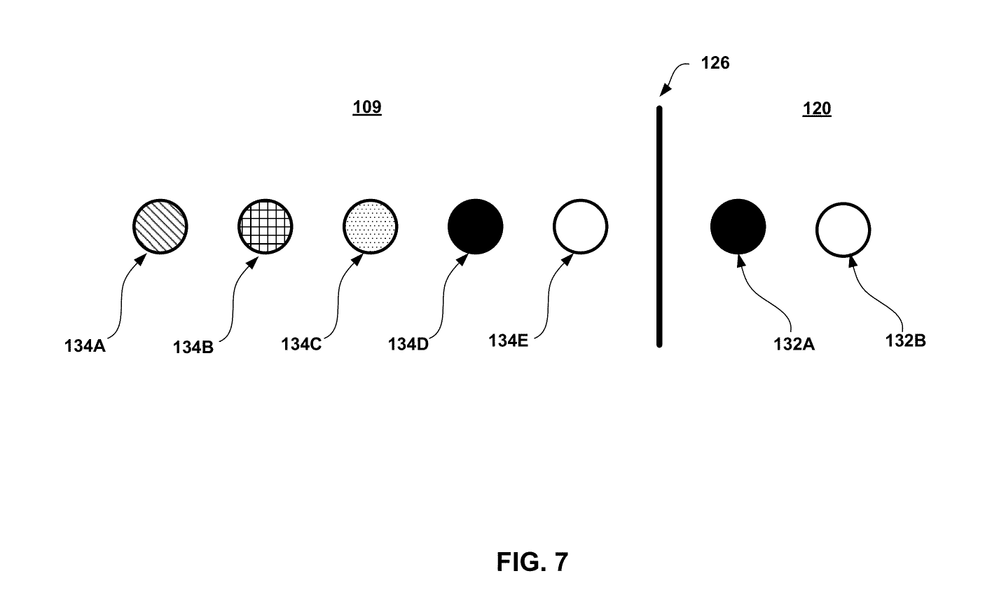

In some examples, rather than pixel copying as the pixel padding method, a video coder, e.g., video encoder 20 and/or video decoder 30, may use other padding schemes, such as segment copying, pattern repetition, mirroring, or the like. FIGS. 7-9 respectively illustrate pixel padding by segment copying, pattern repetition, and mirroring.

FIG. 7 illustrates an example segment copying padding process that may be performed by a video coder. In some examples, a video coder may perform the padding process of FIG. 7 when the number of the pixels to be padded 132A and 132B (collectively “unavailable pixels 132”) in a padding direction e.g., horizontal in the example of FIG. 7, is smaller than the number of neighboring reconstructed pixels 134A-E (collectively “neighboring reconstructed pixels 134”) along the padding direction. In such examples, video encoder 20 and/or video decoder 30 copy a segment of available reconstructed pixels 134 along the padding direction to pad the unavailable pixels 132. For instance, as illustrated in FIG. 7, the video coder (i.e., encoder 20 and/or decoder 30) may pad unavailable pixel 132A with the value of reconstructed neighboring pixel 134D, and pad unavailable pixel 132B with the value of reconstructed neighboring pixel 134E. In this manner, segment copying is used, such that the segment of pixels 134D and 134E is copied for use as unavailable pixels 132A and 132B, respectively. Although a segment of two pixels is shown in FIG. 7, larger segments with a greater number of pixels may be used in some examples.

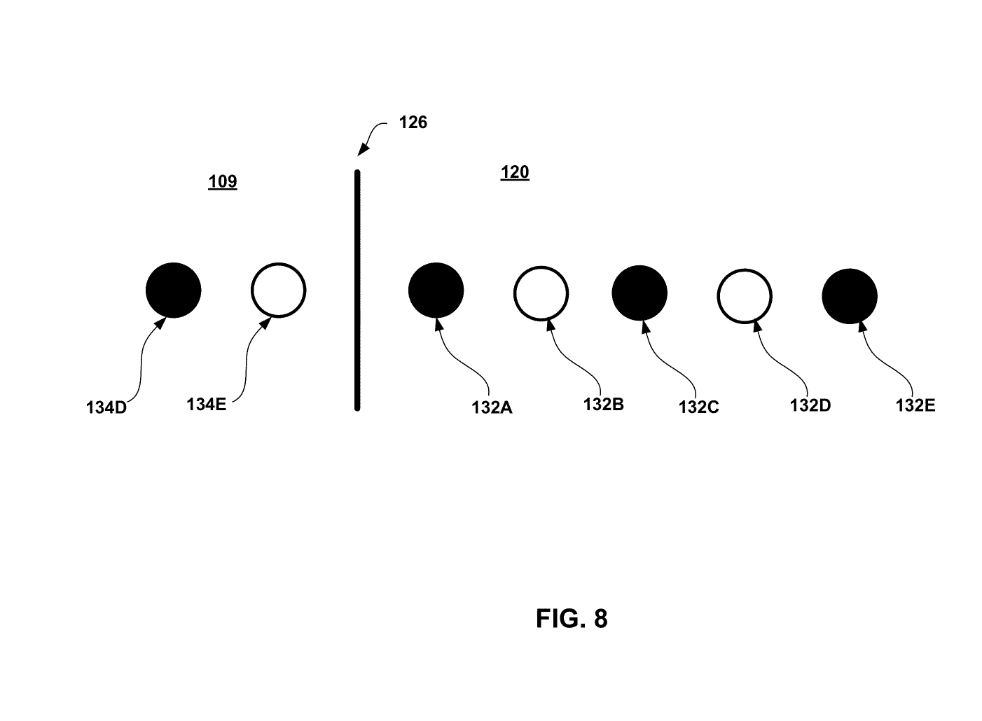

FIG. 8 illustrates an example pattern repetition padding process that may be performed by a video coder. In some examples, a video coder may perform the padding process of FIG. 8 when the number of the pixels to be padded 132A-E (collectively “unavailable pixels 132”) in a padding direction e.g., horizontal in the example of FIG. 8 though a vertical padding direction is also possible, is larger than the number of neighboring reconstructed pixels 134D and 134E (collectively “neighboring reconstructed pixels 134”) along the padding direction. In such examples, video encoder 20 and/or video decoder 30 may repetitively copy a segment of available reconstructed pixels 134 along the padding direction to pad the unavailable pixels 132. For instance, as illustrated in FIG. 8, the video coder may pad unavailable pixel 132A, 132C and 132E with the value of reconstructed neighboring pixel 134D, and pad unavailable pixels 132B and 132D with the value of reconstructed neighboring pixel 134E, e.g., repeating the pattern of values of neighboring reconstructed pixels 134D and 134E in the horizontal direction. Although a pattern of two pixels is shown in FIG. 8, larger patterns with a greater number of pixels may be used and/or patterns may be copied to generate a smaller or larger extent of unavailable pixels.

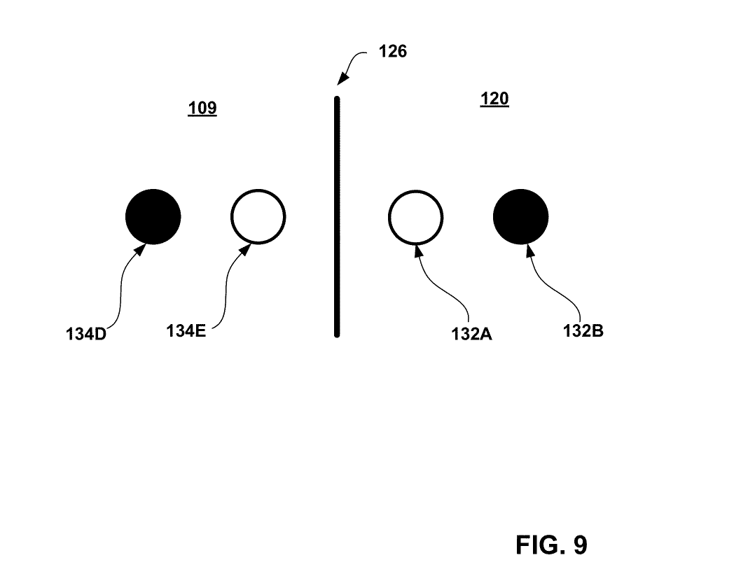

FIG. 9 illustrates an example mirroring padding process that may be performed by a video coder. In such examples, video encoder 20 and/or video decoder 30 may mirror values of the plurality of neighboring reconstructed pixels to the plurality of unavailable pixels across a boundary between reconstructed pixels and non-reconstructed pixels (i.e., boundary 126). For instance, as illustrated in FIG. 9, the video coder may pad unavailable pixel 132A with the value of reconstructed neighboring pixel 134E, and pad unavailable pixel 132B with the value of reconstructed neighboring pixel 134D. Hence, in the mirroring process, the first unavailable pixel on one side of a reconstructed region boundary is generated with the value of the first available pixel on the other side of the reconstructed region boundary, the second unavailable pixel on one side of a reconstructed region boundary is generated with the value of the second available pixel on the other side of the reconstructed region boundary, and so forth. The mirroring process may be performed horizontally across a vertical boundary of the reconstructed region or vertically across a horizontal boundary of the reconstructed region.

In addition, in the examples of FIGS. 7-9, if there are no neighboring reconstructed pixels available for padding an unavailable pixel, e.g., because the nearest reconstructed pixel is greater than a threshold distance from the unavailable pixel, then the value of (2<<(B−1)) may be used for the unavailable pixel, where B is the bitdepth of the input (e.g., video data).

In general, video encoder 20 may identify an intended region for identification of predictor blocks 104 for predicting current video block 102. Video encoder 20 may also determine whether one or more pixels within the intended region are unavailable, e.g., have not been reconstructed, are not within the same picture, tile, or slice as the current video block 102, or the like. Video encoder 20 may obtain values of the unavailable pixels based on values of one or more neighboring reconstructed pixels, e.g., using pixel padding techniques such as those described with respect to FIGS. 6-9. Video encoder 20 may then identify a predictor block 104 that includes at least one of the obtained pixel values, and encode the current video block based on the predictor block, e.g., by determining a residual, and encoding the residual and a block vector identifying the predictor block 104 in the encoded video bitstream.

Similarly, in the Intra BC process, video decoder 30 may determine whether one or more pixels of a predictive block identified by a block vector are outside of a reconstructed region and therefore unavailable, e.g., have not been reconstructed, or are not within the same picture, tile, or slice as the current video block 102, or the like. Video decoder 30 may obtain values of the unavailable pixels based on values of one or more neighboring reconstructed pixels, e.g., using pixel padding techniques such as those described with respect to FIGS. 6-9. Video decoder 30 may identify a predictor block 104 that includes at least one of the obtained pixel values, e.g., based on a block vector identified in the encoded video bitstream by video encoder 20, and reconstruct the current video block based on the predictor block, e.g., by summing a residual included in the encoded bitstream with the predictor block. In some examples, rather than obtaining a pixel value for each unavailable pixels of an entire picture, video decoder 30 may obtain pixel values for unavailable pixels of the predictor block identified by the block vector signal by video encoder 20.

Additionally, in some examples, rather than obtaining pixel values as each block is coded, a video coder may obtain pixel values at the CTU level (i.e., at the basis of CTUs). For instance, before a current CTU is coded, the padding or other pixel obtaining techniques may be performed to obtain values for the unavailable pixels for all the CUs included in the current CTU. It is also possible that the padding operation is at the basis of several CUs or CTUs. Such implementations, e.g., CTU-based padding, may be easier for implementation of the video encoder 20 and/or video decoder 30, as the obtained pixel values for unavailable pixels are fixed at the beginning of the CTU, and there is no need to keep padding at the end of the coding of each CU of the CTU.

The processes for obtaining values of unavailable pixels, e.g., padding processes, according to the techniques of this disclosure may be used in any case when the part of the predictor block or the whole predictor block is unavailable. For example, where the predictor block includes one or more pixels from the current CU, one or more pixels from CUs later in a coding order than the current CU, one or more pixels being out of the current slice/tile, and so on.

It is also possible that the processes for obtaining values of unavailable pixels, e.g., padding processes, according to the techniques of this disclosure may only be performed for a certain pre-defined region. For example, the processes may be used to pad the region of a current CU or CTU. After the padding, the corresponding restriction of MV used for Intra BC should be changed accordingly such that the all of the samples in a given predictor block are either reconstructed or padded.

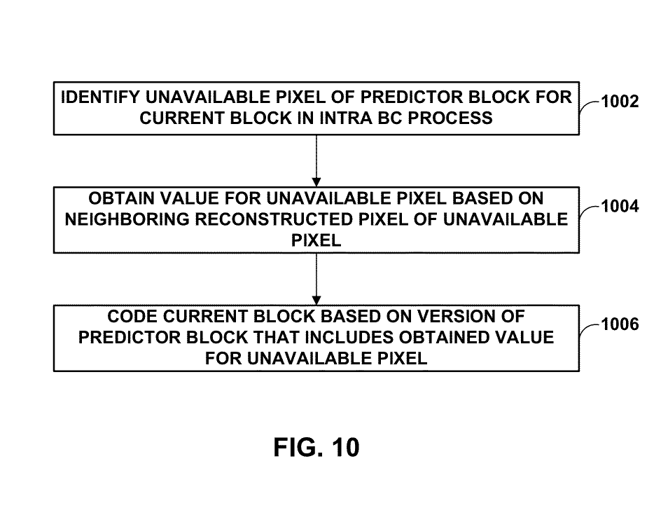

FIG. 10 is a flow diagram illustrating example operations of a video coder to code a current block within a current picture based on a predictor block within the current picture that includes at least one pixel located outside of a reconstructed region of the current picture, in accordance with one or more techniques of the present disclosure. The techniques of FIG. 10 may be performed by one or more video coders, such as video encoder 20 illustrated in FIGS. 1 and 2, and/or video decoder 30 illustrated in FIGS. 1 and 3. For purposes of illustration, the techniques of FIG. 10 are described within the context of video decoder 30, although video coders having configurations different than that of video decoder 30 may perform the techniques of FIG. 10.

In accordance with one or more techniques of this disclosure, video decoder 30 may identify an unavailable pixel of a predictor block for a current block in an Intra BC process (1002). In some examples, video decoder 30 may identify the predictor block based on a block vector that represents a position of the predictor block relative to the current block. In some examples, the unavailable pixel may be located outside of a reconstructed region of a current picture, where the current picture includes the current block. For instance, video decoder 30 may identify a pixel of predictor block 105A that overlaps current block 103A of FIG. 5A.

Video decoder 30 may obtain a value for the unavailable pixel based on at least one neighboring reconstructed pixel of the unavailable pixel (1004). In some examples, video decoder 30 may obtain the value for the unavailable pixel based on the at least one neighboring reconstructed pixel of the unavailable pixel by padding the unavailable pixel with a value determined based on the at least one neighboring reconstructed pixel of the unavailable pixel. As one example, video decoder 30 may determine which pixel of the at least one neighboring reconstructed pixel is nearest to the unavailable pixel, and copy the value of the determined nearest neighboring reconstructed pixel to the unavailable pixel. In some examples, such as where video decoder 30 obtains values for a plurality of unavailable pixels, video decoder 30 may pad the plurality of unavailable pixels using the segment copying, pattern repetition, or mirroring techniques respectively discussed above with reference to FIGS. 7-9.

In any case, video decoder 30 may decode the current block based on a version of the predictor block that includes the obtained value for the unavailable pixel (1006). For instance, video decoder 30 may generate pixel values for the current block based on a residual block that represents pixel differences between the version of the predictor block that includes the obtained value for the unavailable pixel and the current block. In this way, video decoder 30 may utilize predictor blocks that include one or more unavailable pixels to decode blocks of video data.

The following examples may illustrate one or more aspects of the disclosure:

### Example 1

A method of encoding or decoding a current video block within a current picture based on a predictor block within the current picture, the predictor block identified by a block vector, the method comprising: identifying an unavailable pixel of the predictor block, wherein the unavailable pixel is located outside of a reconstructed region of the current picture; obtaining a value for the unavailable pixel based on at least one neighboring reconstructed pixel of the unavailable pixel; and encoding or decoding the current video block based on a version of the predictor block that includes the obtained value for the unavailable pixel.

### Example 2

The method of example 1, wherein the unavailable pixel is located within the current video block.

### Example 3

The method of any combination of examples 1-2, wherein the unavailable pixel is located within one or more of: a video block located later in a coding order than the current video block, a different tile than the current video block, a different slice then the current video block, and a different coding tree unit then the current video block.

### Example 4

The method of any combination of examples 1-3, wherein obtaining the value for the unavailable pixel based on at least one neighboring reconstructed pixel of the unavailable pixel comprises: padding the unavailable pixel with a value determined based on the at least one neighboring reconstructed pixel of the unavailable pixel.

### Example 5

The method of any combination of examples 1-4, wherein padding the unavailable pixel with the value determined based on the at least one neighboring reconstructed pixel of the unavailable pixel comprises: copying the value of a neighboring reconstructed pixel to the unavailable pixel.

### Example 6

The method of any combination of examples 1-5, wherein padding the unavailable pixel with the value determined based on the at least one neighboring reconstructed pixel of the unavailable pixel comprises: copying values of a plurality of neighboring reconstructed pixels to a plurality of unavailable pixels along a padding direction.

### Example 7

The method of any combination of examples 1-6, wherein copying values of the plurality of neighboring reconstructed pixels to the plurality of unavailable pixels along the padding direction comprises one or more of: copying a segment of values of the plurality of neighboring reconstructed pixels to the plurality of unavailable pixels; mirroring values of the plurality of neighboring reconstructed pixels to the plurality of unavailable pixels across a boundary between reconstructed pixels and non-reconstructed pixels; or repetitively copying a pattern of values of the plurality of neighboring reconstructed pixels to the plurality of unavailable pixels.

### Example 8

The method of any combination of examples 1-7, wherein padding the unavailable pixel with a value determined based on the at least one neighboring reconstructed pixel of the unavailable pixel comprises: padding the unavailable pixel with a value determined based on a nearest neighboring reconstructed pixel of the unavailable pixel.

### Example 9

The method of any combination of examples 1-8, wherein identifying the unavailable pixel comprises identifying a plurality of unavailable pixels, and obtaining the value for the unavailable pixel comprises obtaining a respective value for each unavailable pixel of the plurality of unavailable pixels, the method further comprising: padding each of the plurality of unavailable pixels with a respective value determined based on a respective nearest neighboring reconstructed pixel such that unavailable pixels of the plurality of unavailable pixels that have a respective nearest horizontal neighboring pixel located a same distance away as a respective nearest vertical neighboring pixel are either all padded with their respective nearest vertical neighboring pixels or all padded with their respective nearest horizontal neighboring pixels.

### Example 10

The method of any combination of examples 1-9, wherein padding the unavailable pixel with a value determined based on the at least one neighboring reconstructed pixel of the unavailable pixel comprises: if a horizontal neighboring pixel is available, padding the unavailable pixel with a value determined based on the horizontal neighboring pixel; if a horizontal neighboring pixel is unavailable and a vertical neighboring pixel is available, padding the unavailable pixel with a value determined based on the vertical neighboring pixel; and if horizontal and vertical neighboring pixels are unavailable, padding the unavailable pixel with a value determined based on a nearest available reconstructed pixel.

### Example 11

The method of any combination of examples 1-10, wherein padding the unavailable pixel with a value determined based on the at least one neighboring reconstructed pixel of the unavailable pixel comprises: if a vertical neighboring pixel is available, padding the unavailable pixel with a value determined based on the vertical neighboring pixel; if a vertical neighboring pixel is unavailable and a horizontal neighboring pixel is available, padding the unavailable pixel with a value determined based on the horizontal neighboring pixel; and if horizontal and vertical neighboring pixels are unavailable, padding the unavailable pixel with a value determined based on a nearest available reconstructed pixel.

### Example 12

The method of any combination of examples 1-11, further comprising: responsive to determining that no reconstructed pixels neighbor the unavailable pixel, determining the value for the unavailable pixel based on a bitdepth of pixel values of the current video block; and encoding or decoding the current video block based on a predictor block including the determined value for the unavailable pixel.

### Example 13

The method of any combination of examples 1-12, further comprising: obtaining the value for the unavailable pixel prior to coding video blocks of a current coding tree unit that includes the current video block.

### Example 14

The method of any combination of examples 1-13, further comprising: determining whether the unavailable pixel is within a predetermined region of the current picture that comprises the current video block, wherein obtaining a value for the unavailable pixel based on at least one neighboring reconstructed pixel of the unavailable pixel comprises: obtaining a value for the unavailable pixel based on at least one neighboring reconstructed pixel of the unavailable pixel if the unavailable pixel is within the predetermined region.

### Example 15

A device for encoding or decoding a current video block within a current picture based on a predictor block within the current picture, the predictor block identified by a block vector, the device comprising: a memory configured to store data associated with the current picture; and one or more processors configured to: identify an unavailable pixel of the predictor block, wherein the unavailable pixel is located outside of a reconstructed region of the current picture; obtain a value for the unavailable pixel based on at least one neighboring reconstructed pixel of the unavailable pixel; and encode or decode the current video block based on a version of the predictor block that includes the obtained value for the unavailable pixel.

### Example 16

The device of example 15, wherein the one or more processors are configured to perform the method of any combination of examples 1-14.

### Example 17

A device for encoding or decoding a current video block within a current picture based on a predictor block within the current picture, the predictor block identified by a block vector, the device comprising: means for identifying an unavailable pixel of the predictor block, wherein the unavailable pixel is located outside of a reconstructed region of the current picture; means for obtaining a value for the unavailable pixel based on at least one neighboring reconstructed pixel of the unavailable pixel; and means for encoding or decoding the current video block based on a version of the predictor block that includes the obtained value for the unavailable pixel.

### Example 18

The device of example 17, further comprising means for performing the method of any combination of examples 1-14.

### Example 19

A computer-readable storage medium storing instructions that, when executed, cause one or more processors of a device to encode or decode the current video block by at least: identifying an unavailable pixel of the predictor block, wherein the unavailable pixel is located outside of a reconstructed region of the current picture; obtaining a value for the unavailable pixel based on at least one neighboring reconstructed pixel of the unavailable pixel; and encoding or decoding the current video block based on a version of the predictor block that includes the obtained value for the unavailable pixel.

### Example 20

The computer-readable storage medium of example 19, further storing instructions that, when executed, cause the one or more processors to perform the method of any combination of examples 1-14.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of encoding or decoding a current video block within a current picture based on a predictor block within the current picture, the predictor block identified by a block vector, the method comprising:
identifying an unavailable pixel of the predictor block, wherein the unavailable pixel is located outside of a reconstructed region of the current picture;
obtaining a value for the unavailable pixel based on at least one neighboring reconstructed pixel of the unavailable pixel; and
encoding or decoding the current video block based on a version of the predictor block that includes the obtained value for the unavailable pixel.

2. The method of claim 1, wherein the unavailable pixel is located within the current video block.

3. The method of claim 1, wherein the unavailable pixel is located within one or more of:
a video block located later in a coding order than the current video block,
a different tile than the current video block,
a different slice then the current video block, and
a different coding tree unit then the current video block.

4. The method of claim 1, wherein obtaining the value for the unavailable pixel based on at least one neighboring reconstructed pixel of the unavailable pixel comprises:
padding the unavailable pixel with a value determined based on the at least one neighboring reconstructed pixel of the unavailable pixel.

5. The method of claim 4, wherein padding the unavailable pixel with the value determined based on the at least one neighboring reconstructed pixel of the unavailable pixel comprises:
copying the value of a neighboring reconstructed pixel to the unavailable pixel.

6. The method of claim 4, wherein padding the unavailable pixel with the value determined based on the at least one neighboring reconstructed pixel of the unavailable pixel comprises:
copying values of a plurality of neighboring reconstructed pixels to a plurality of unavailable pixels along a padding direction.

7. The method of claim 6, wherein copying values of the plurality of neighboring reconstructed pixels to the plurality of unavailable pixels along the padding direction comprises one or more of:
copying a segment of values of the plurality of neighboring reconstructed pixels to the plurality of unavailable pixels;
mirroring values of the plurality of neighboring reconstructed pixels to the plurality of unavailable pixels across a boundary between reconstructed pixels and non-reconstructed pixels; or
repetitively copying a pattern of values of the plurality of neighboring reconstructed pixels to the plurality of unavailable pixels.

8. The method of claim 4, wherein padding the unavailable pixel with a value determined based on the at least one neighboring reconstructed pixel of the unavailable pixel comprises:
padding the unavailable pixel with a value determined based on a nearest neighboring reconstructed pixel of the unavailable pixel.

9. The method of claim 8, wherein identifying the unavailable pixel comprises identifying a plurality of unavailable pixels, and obtaining the value for the unavailable pixel comprises obtaining a respective value for each unavailable pixel of the plurality of unavailable pixels, the method further comprising:
padding each of the plurality of unavailable pixels with a respective value determined based on a respective nearest neighboring reconstructed pixel such that unavailable pixels of the plurality of unavailable pixels that have a respective nearest horizontal neighboring pixel located a same distance away as a respective nearest vertical neighboring pixel are either all padded with their respective nearest vertical neighboring pixels or all padded with their respective nearest horizontal neighboring pixels.

10. The method of claim 4, wherein padding the unavailable pixel with a value determined based on the at least one neighboring reconstructed pixel of the unavailable pixel comprises:
if a horizontal neighboring pixel is available, padding the unavailable pixel with a value determined based on the horizontal neighboring pixel;
if a horizontal neighboring pixel is unavailable and a vertical neighboring pixel is available, padding the unavailable pixel with a value determined based on the vertical neighboring pixel; and
if horizontal and vertical neighboring pixels are unavailable, padding the unavailable pixel with a value determined based on a nearest available reconstructed pixel.

11. The method of claim 4, wherein padding the unavailable pixel with a value determined based on the at least one neighboring reconstructed pixel of the unavailable pixel comprises:
if a vertical neighboring pixel is available, padding the unavailable pixel with a value determined based on the vertical neighboring pixel;
if a vertical neighboring pixel is unavailable and a horizontal neighboring pixel is available, padding the unavailable pixel with a value determined based on the horizontal neighboring pixel; and
if horizontal and vertical neighboring pixels are unavailable, padding the unavailable pixel with a value determined based on a nearest available reconstructed pixel.

12. The method of claim 1, further comprising:
responsive to determining that no reconstructed pixels neighbor the unavailable pixel, determining the value for the unavailable pixel based on a bitdepth of pixel values of the current video block; and
encoding or decoding the current video block based on a predictor block including the determined value for the unavailable pixel.

13. The method of claim 1, further comprising:
obtaining the value for the unavailable pixel prior to coding video blocks of a current coding tree unit that includes the current video block.

14. The method of claim 1, further comprising:
determining whether the unavailable pixel is within a predetermined region of the current picture that comprises the current video block, wherein obtaining a value for the unavailable pixel based on at least one neighboring reconstructed pixel of the unavailable pixel comprises:
obtaining a value for the unavailable pixel based on at least one neighboring reconstructed pixel of the unavailable pixel if the unavailable pixel is within the predetermined region.

15. A device for encoding or decoding a current video block within a current picture based on a predictor block within the current picture, the predictor block identified by a block vector, the device comprising:
a memory configured to store data associated with the current picture; and
one or more processors configured to:
identify an unavailable pixel of the predictor block, wherein the unavailable pixel is located outside of a reconstructed region of the current picture;
obtain a value for the unavailable pixel based on at least one neighboring reconstructed pixel of the unavailable pixel; and
encode or decode the current video block based on a version of the predictor block that includes the obtained value for the unavailable pixel.

16. The device of claim 15, wherein the unavailable pixel is located within the current video block.

17. The device of claim 15, wherein the unavailable pixel is located within one or more of:
a video block located later in a coding order than the current video block,
a different tile than the current video block,
a different slice then the current video block, and
a different coding tree unit then the current video block.

18. The device of claim 15, wherein the one or more processors are configured to obtain the value for the unavailable pixel based on at least one neighboring reconstructed pixel of the unavailable pixel by at least:
padding the unavailable pixel with a value determined based on the at least one neighboring reconstructed pixel of the unavailable pixel.

19. The device of claim 18, wherein the one or more processors are configured to pad the unavailable pixel with the value determined based on the at least one neighboring reconstructed pixel of the unavailable pixel by at least:
copying the value of a neighboring reconstructed pixel to the unavailable pixel.

20. The device of claim 18, wherein the one or more processors are configured to pad the unavailable pixel with the value determined based on the at least one neighboring reconstructed pixel of the unavailable pixel by at least copying values of a plurality of neighboring reconstructed pixels to a plurality of unavailable pixels along a padding direction, wherein the one or more processors are configured to copy the values of the plurality of neighboring reconstructed pixels to the plurality of unavailable pixels along the padding direction by at least one or more of:
copying a segment of values of the plurality of neighboring reconstructed pixels to the plurality of unavailable pixels;
mirroring values of the plurality of neighboring reconstructed pixels to the plurality of unavailable pixels across a boundary between reconstructed pixels and non-reconstructed pixels; or
repetitively copying a pattern of values of the plurality of neighboring reconstructed pixels to the plurality of unavailable pixels.

21. The device of claim 18, wherein the one or more processors are configured to pad the unavailable pixel with a value determined based on the at least one neighboring reconstructed pixel of the unavailable pixel by at least:
padding the unavailable pixel with a value determined based on a nearest neighboring reconstructed pixel of the unavailable pixel.

22. The device of claim 21, wherein the one or more processors are configured to:
identify the unavailable pixel by at least identifying a plurality of unavailable pixels,
obtain the value for the unavailable pixel by at least obtaining a respective value for each unavailable pixel of the plurality of unavailable pixels, and
pad each of the plurality of unavailable pixels with a respective value determined based on a respective nearest neighboring reconstructed pixel such that unavailable pixels of the plurality of unavailable pixels that have a respective nearest horizontal neighboring pixel located a same distance away as a respective nearest vertical neighboring pixel are either all padded with their respective nearest vertical neighboring pixels or all padded their respective nearest horizontal neighboring pixels.

23. The device of claim 18, wherein the one or more processors are configured to pad the unavailable pixel with a value determined based on the at least one neighboring reconstructed pixel of the unavailable pixel by at least:
if a horizontal neighboring pixel is available, padding the unavailable pixel with a value determined based on the horizontal neighboring pixel;
if a horizontal neighboring pixel is unavailable and a vertical neighboring pixel is available, padding the unavailable pixel with a value determined based on the vertical neighboring pixel; and
if horizontal and vertical neighboring pixels are unavailable, padding the unavailable pixel with a value determined based on a nearest available reconstructed pixel.

24. The device of claim 18, wherein the one or more processors are configured to pad the unavailable pixel with a value determined based on the at least one neighboring reconstructed pixel of the unavailable pixel by at least:
if a vertical neighboring pixel is available, padding the unavailable pixel with a value determined based on the vertical neighboring pixel;
if a vertical neighboring pixel is unavailable and a horizontal neighboring pixel is available, padding the unavailable pixel with a value determined based on the horizontal neighboring pixel; and
if horizontal and vertical neighboring pixels are unavailable, padding the unavailable pixel with a value determined based on a nearest available reconstructed pixel.

25. The device of claim 15, wherein the one or more processors are further configured to:
responsive to determining that no reconstructed pixels neighbor the unavailable pixel, determine the value for the unavailable pixel based on a bitdepth of pixel values of the current video block; and
encode or decode the current video block based on a predictor block including the determined value for the unavailable pixel.

26. The device of claim 15, wherein the one or more processors are further configured to:
obtain the value for the unavailable pixel prior to coding video blocks of a current coding tree unit that includes the current video block.

27. A device for encoding or decoding a current video block within a current picture based on a predictor block within the current picture, the predictor block identified by a block vector, the device comprising:
means for identifying an unavailable pixel of the predictor block, wherein the unavailable pixel is located outside of a reconstructed region of the current picture;
means for obtaining a value for the unavailable pixel based on at least one neighboring reconstructed pixel of the unavailable pixel; and
means for encoding or decoding the current video block based on a version of the predictor block that includes the obtained value for the unavailable pixel.

28. The device of claim 27, wherein the unavailable pixel is located within the current video block.

29. A computer-readable storage medium storing instructions that, when executed, cause one or more processors of a device to encode or decode the current video block by at least:
identifying an unavailable pixel of the predictor block, wherein the unavailable pixel is located outside of a reconstructed region of the current picture;
obtaining a value for the unavailable pixel based on at least one neighboring reconstructed pixel of the unavailable pixel; and
encoding or decoding the current video block based on a version of the predictor block that includes the obtained value for the unavailable pixel.

30. The computer-readable storage medium of claim 29, wherein the unavailable pixel is located within the current video block.
